(19) United States
(12) Patent Application Publication
(10) Pub. No.: US 2014/0004314 A1
(43) Pub. Date: Jan. 2, 2014

(54) TRIM ELEMENT AND ASSOCIATED MANUFACTURING METHOD

(71) Applicant: Faurecia Interieur Industrie, Nanterre (FR)

(72) Inventors: Nathalie Durand, Amberieu en Bugey (FR); Hugo Piccin, Munich (DE)

(73) Assignee: Faurecia Interieur Industrie, Nanterre (FR)

(21) Appl. No.: 13/918,187

(22) Filed: Jun. 14, 2013

(30) Foreign Application Priority Data
Jun. 14, 2012 (FR) 12 55560

(51) Int. Cl. B60R 13/02; B29C 65/00

(52) U.S. Cl. CPC B60R 13/02; B29C 65/002
USPC 428/174; 156/245; 428/537.1; 428/339; 428/412; 428/480; 428/474.4; 428/523; 428/522; 428/521

(57) ABSTRACT

A vehicle trim element that includes a complex formed from at least one layer of ligneous material and a reinforcing layer that extends over an inner face of the layer of ligneous material. The trim element further includes a substrate made from a first plastic material and at least one insert made from a second plastic material. The insert is located between the reinforcing layer of the complex and the substrate so as to space the substrate away from the reinforcing layer. The substrate is overmolded by injection on the insert.

### TECHNICAL FIELD

The present invention relates to a vehicle trim element formed from a substrate and a complex of a ligneous material layer and a reinforcing layer.

### BACKGROUND

In vehicles, for example motor vehicles, trim elements make it possible to improve the appearance of the passenger compartment for example by forming panels, for doors or other parts, whereof the visible surface is arranged to impart a satisfactory esthetic appearance. To that end, trim elements are for example provided whose visible surfaces are formed by a ligneous material, such as wood. Using a trim element covered with wood imparts a luxurious appearance to the passenger compartment.

Document FR-2 949 376 describes a method for manufacturing a trim element covered with a layer of ligneous material, wherein a substrate made from plastic is directly overmolded on the back side of a complex formed by at least one layer of ligneous material, on the back side of which a reinforcing layer, for example made from a textile material, is glued.

Such a method is not fully satisfactory. Indeed, the overmolding of the substrate requires injecting plastic material onto the complex at high pressures and temperatures, which risks damaging the layer of ligneous material, in particular by creating burn marks thereon, and consequently deteriorating the esthetic appearance of the trim element.

### SUMMARY

One aim of the invention is to propose a trim element comprising a coating made from a ligneous material, but that is inexpensive and easy to produce, and that has a satisfactory esthetic appearance.

To that end, the invention relates to a trim element of the aforementioned type, in which the trim element further comprises at least one insert, made from a second plastic material, inserted between the reinforcing layer of the complex and the substrate so as to space the substrate away from the reinforcing layer, the substrate being overmolded by injection on the insert.

According to specific embodiments, the trim element has one or more of the following features, considered alone or according to any technically possible combination(s):

the complex further comprises a protective layer adhering to the outer face of the layer of ligneous material;

the trim element has a three-dimensional outer surface;

the insert has a thickness greater than 0.1 mm;

the second plastic material is chosen from the list consisting of: polyester, polyamide, polyethylene, polypropylene, polycarbonate, acrylonitrile butadiene styrene, acrylic, poly(methyl methacrylate), polybutylene succinate, polybutylene terephthalate, polypropylene terephthalate (PPT), polylactic acid and mixtures of at least two of the aforementioned materials;

the first and/or second plastic materials contain fibers; and

the substrate comprises at least one functional member made in a single piece with the substrate.

The invention also relates to a method for manufacturing a trim element, comprising:

providing an insert made from a plastic material;

providing a complex comprising at least one layer of ligneous material having an outer face and an inner face, and a reinforcing layer extending over the inner face of the layer of ligneous material;

assembling the complex to the insert to form an intermediate assembly;

forming the substrate by injection molding the plastic material on the intermediate assembly.

According to other embodiments, the method comprises one or more of the following features, considered alone or according to any technically possible combination(s):

the insert is shaped separately before being assembled to the complex;

the trim element has a three-dimensional outer surface and the insert is shaped separately according to its final three-dimensional shape in the trim element before being assembled to the complex;

the insert is shaped by injection molding, compression or thermocompression; and

the insert is assembled to the complex by pressing the insert against the complex.

### BRIEF DESCRIPTION OF THE DRAWINGS

The invention will be better understood upon reading the following description, provided solely as an example and done in reference to the appended drawings, in which:

FIG. 1 is a diagrammatic cross-sectional illustration of a trim element according to the invention;

FIGS. 2 to 4 are diagrammatic illustrations of the manufacturing method according to the invention; and

FIG. 5 is a diagrammatic illustration similar to FIG. 2 of one step of an alternative of the manufacturing method.

### DETAILED DESCRIPTION

In the rest of the description, the term “outer” is used to refer to the face of an element oriented on the side of the visible face of the trim element, and the term “inner” is used to designate the face of an element oriented opposite the visible face.

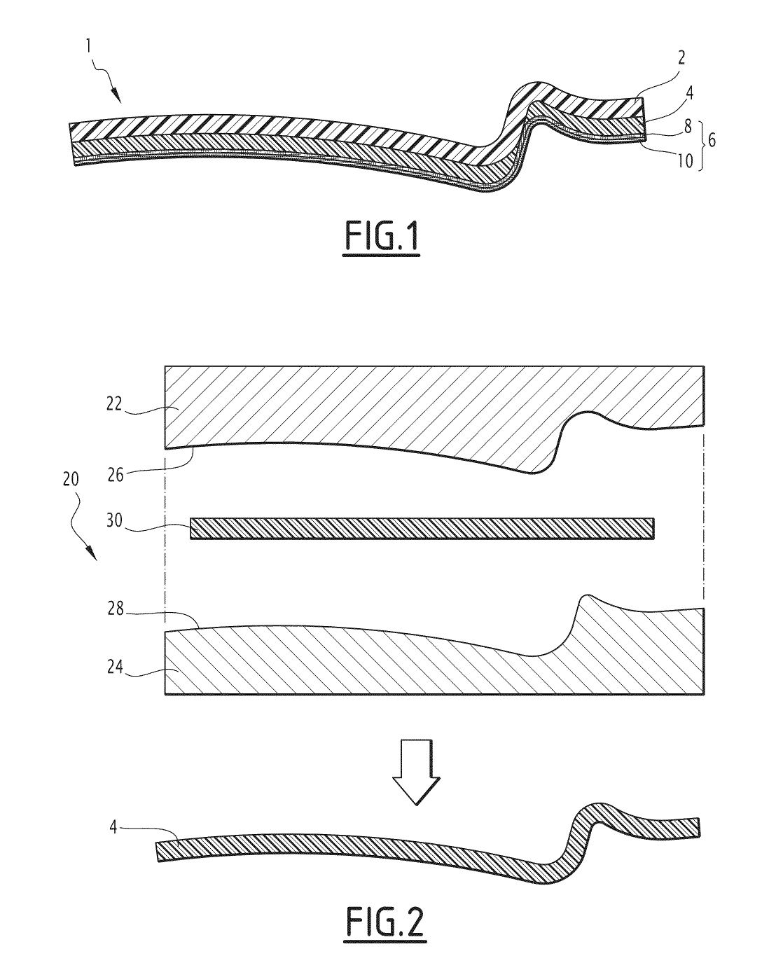

In reference to FIG. 1, a trim element 1 is described comprising, from the inside toward the outside, a substrate 2, made from a first plastic material, an insert 4, made from a second plastic material, and a complex 6. The complex 6 forms the visible face of the trim element 1. It comprises, from the inside toward the outside, a reinforcing layer 8 and at least one layer of ligneous material 10. The outer face of the insert 4 is applied against the inner face of the complex 6, in particular the inner face of the reinforcing layer 8. The inner face of the insert 4 is applied against the outer face of the substrate 2.

Such a trim element 1 is for example intended to form a trim panel for the passenger compartment of a vehicle, for example a motor vehicle. Such a trim panel is for example a door panel or dashboard covering, inter alia.

The trim element 1 for example has a three-dimensional outer surface. This three-dimensional shape is a developable or non-developable shape.

The layer of ligneous material 10 is visible from the outside, for example from the passenger compartment of the vehicle. It is for example a layer of natural wood. As shown in FIG. 1, the complex 6 comprises a single layer of ligneous material 10. Optionally, the complex 6 comprises several layers of ligneous material 10 superimposed and glued together.

The reinforcing layer 8 extends over an inner face, or non-visible face, of the layer of ligneous material 10.

The reinforcing layer 8 is made from a non-plastic material.

The reinforcing layer 8 is for example a layer of a textile material, for example a woven fabric or a nonwoven fabric. It is optionally made from paper or cardboard.

A function of the reinforcing layer 8 is to reinforce the layer of ligneous material 10 on the inner face thereof, and optionally to promote bonding with the insert 4.

The reinforcing layer 8 is for example laminated on the inner face of the layer of ligneous material 10.

Optionally, the complex 6 comprises a protective layer (not shown) extending over an outer face, or visible face of the layer of ligneous material 10. The protective layer is for example made from a thermosetting or thermoplastic material. This protective layer serves in particular to protect the layer of ligneous material 10 from outside attacks, in particular from ultraviolet radiation that may cause accelerated aging of the layer of ligneous material 10. The protective layer is further designed to leave the layer of ligneous material 10 visible from outside the trim element 1 by being translucent or transparent. It may also be used to modify the appearance of the trim element 1, for example by being colored or particularly shiny.

The insert 4 is inserted between the reinforcing layer 8 and the substrate 2. It has an inner face, applied against an outer face of the substrate 2, and an outer face, applied against an inner face of the reinforcing layer 8.

The insert 4 is made from the second plastic material, for example polyester, polyamide (PA), polyethylene (PE), polypropylene (PP), polycarbonate (PC), acrylonitrile butadiene styrene (ABS), acrylic, poly(methyl methacrylate) (PMMA), polybutylene succinate (PBS), polybutylene terephthalate (PBT), polypropylene terephthalate (PPT), polylactic acid (PLA), or mixtures of at least two of said materials. These materials may further be reinforced with fibers, such as glass or carbon fibers or natural fibers, from among plant fibers in particular chosen from the group consisting of cotton, flax, hemp, Manila hemp or abaca, banana tree, jute, ramie, raffia, sisal, broom, bamboo, miscanthus, kenaf, coir, agave, sorgho, switchgrass and wood, and/or animal fibers, in particular chosen from the group consisting of wool, alpaca, mohair, cashmere, angora and silk. The composition comprises a quite variable percentage of fibers from 10% to 80%, depending on the nature thereof and on the method for shaping the insert 4 and the geometric complexity of the trim element.

The insert 4 must have an expansion coefficient close to that of the substrate 2, such that these layers have similar mechanical behaviors, which makes it possible to avoid warping of the finished piece as well as the appearance of cracks or fissures on the layer of ligneous material 10. The insert 4 in particular has a thickness greater than 0.1 mm and preferably comprised between 1.5 and 2.2 mm.

The first and second plastic materials may be substantially identical. They may also be different.

The insert 4 spaces the substrate 2 away from the complex 6, in particular from the reinforcing layer 8. It thereby protects the complex 6 during formation of the substrate 2.

The substrate 2 is formed on the inner face of the insert 4. It is obtained by injection molding of the first plastic material on the insert 4. The substrate 2 at least partially covers the insert 4. In the overlap area between the substrate 2 and the insert 4, the outer face of the substrate 2 hugs the inner face of the insert 4. The substrate 2 may comprise functional members, for example fastening members for fastening the trim element 2 to a metal structural panel of the vehicle. These functional members are molded integrally with the substrate 2. The addition of these functional members is made possible because the substrate 2 is made by injection. Such members could not be provided in a single piece with the substrate 2 if the latter were made by compression.

The first plastic material is preferably chosen from the list consisting of: polyester, polyamide (PA), polyethylene (PE), polypropylene (PP), polycarbonate (PC), acrylonitrile butadiene styrene (ABS), acrylic, poly(methyl methacrylate) (PMMA), polybutylene succinate (PBS), polybutylene terephthalate (PBT), polypropylene terephthalate (PPT), polylactic acid (PLA), or mixtures of at least two of said materials. These materials may further be reinforced with fibers, such as glass or carbon fibers or natural fibers, from among plant fibers in particular chosen from the group consisting of cotton, flax, hemp, Manila hemp or abaca, banana tree, jute, ramie, raffia, sisal, broom, bamboo, miscanthus, kenaf, coir, agave, sorgho, switchgrass and wood, and/or animal fibers, in particular chosen from the group consisting of wool, alpaca, mohair, cashmere, angora and silk. The composition typically comprises from 10 to 40 wt%, in particular from 20 to 35 wt%, preferably from 25 to 30 wt% of fibers.

The method for manufacturing the trim element 1 is described hereafter in reference to FIGS. 2 to 4. It comprises the following steps:

Providing the preformed insert 2. Preformed means that the insert 4 is provided in the final shape that it has in the trim element 1 (FIG. 2).

Providing the complex 6;

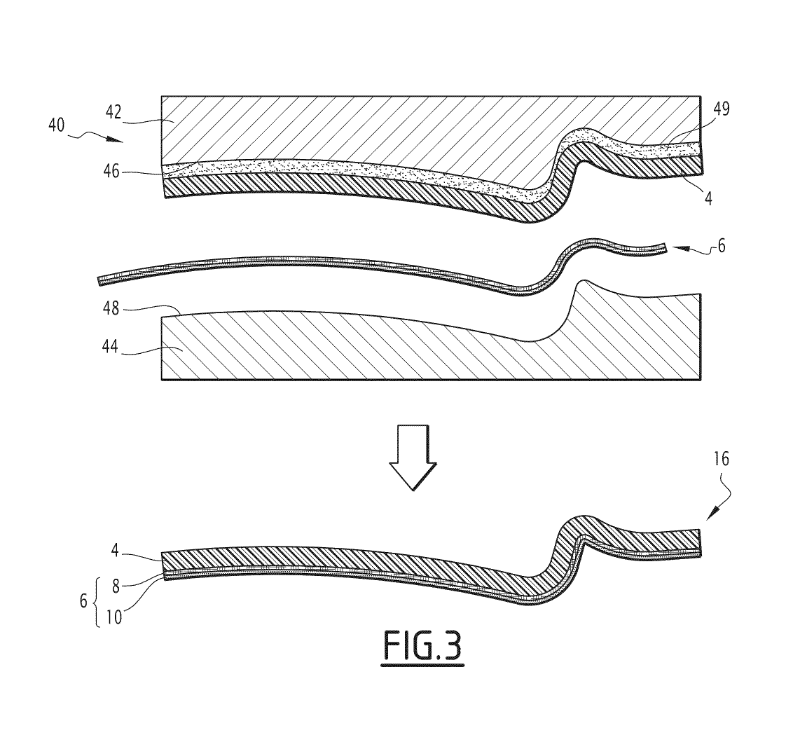

Assembling the preformed insert 2 to the complex 6 to form an intermediate assembly 16 (FIG. 3); then

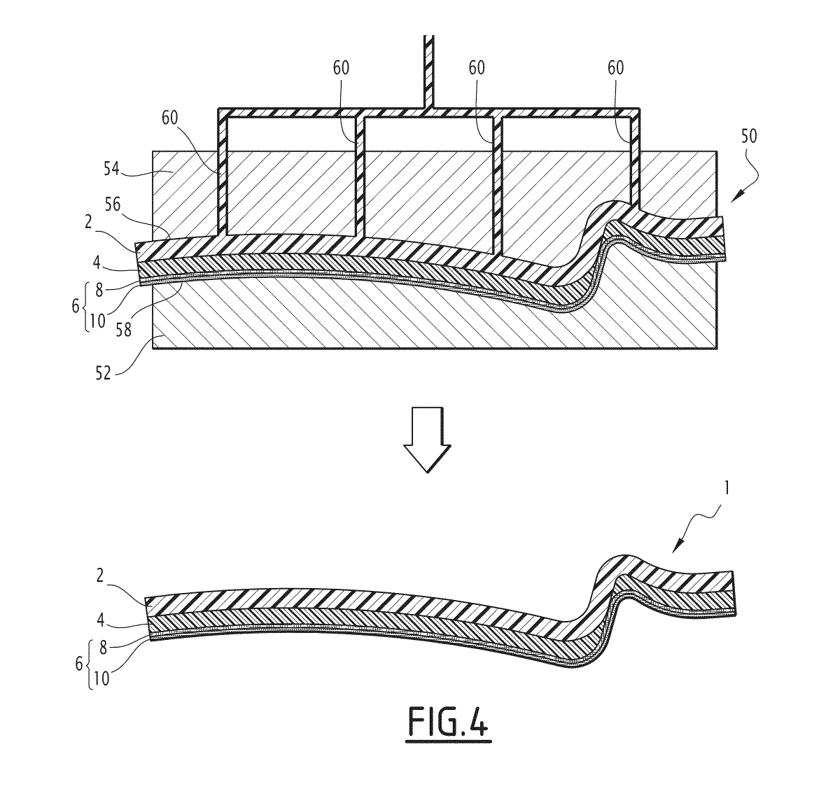

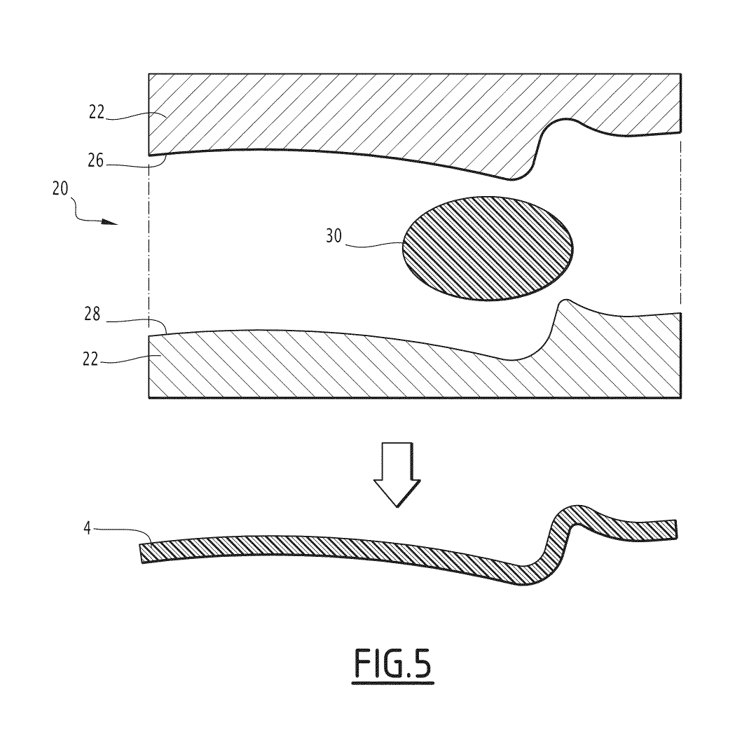

Forming the substrate 2 on the intermediate assembly 16, in particular on the insert 4 so as to obtain the trim element 1 (FIG. 4).

The step for providing the insert 4 comprises a step for shaping the insert 4. According to a first embodiment, the insert 4 is shaped by compression molding in a suitable compression molding mold 20. Such a compression molding mold, illustrated in FIG. 2 in an open position, conventionally comprises a first compression molding mold portion 22 and a second compression molding mold portion 24, movable relative to one another between an open position of the mold 20 and a closed position of the mold 20. The first portion 22 and the second portion 24 respectively comprise a first shaping surface 26 and a second shaping surface 28 with a complementary shape corresponding to the desired final shape of the insert 4. In the closed position of the mold 20, the shaping surfaces 26, 28 define a shaping cavity between them with a shape corresponding to the desired shape of the insert 4.

The step for shaping the insert 4 is diagrammatically illustrated in FIG. 2. The compression molding mold 20 is initially open. The plastic starting material 30 intended to form the insert 4 is then introduced into the mold 20. In the example illustrated in FIG. 2, it is introduced into the mold 20 in the form of a sheet, for example made from a thermoplastic or thermosetting material or in the form of SMC (Sheet Molding Compound), i.e., a sheet formed by a preimpregnated mat.

In the alternative illustrated in FIG. 5, the plastic starting material 30 is introduced in the form of a paste, in particular in the form of BMC (Bulk Molding Compound), i.e., a mass to be molded.

The mold 20 is then closed, thereby bringing the first and second shaping surfaces 26, 28 closer to each other. Because the surfaces 26, 28 come closer together, the plastic starting material present in the mold 20 is compressed and is distributed in the shaping cavity.

After cooling if necessary, the mold 20 is opened, and the insert 4 thus obtained is stripped.

At the end of this shaping step, a preformed insert 4 is obtained, having its final shape as found in the trim element 1.

According to one alternative, the preformed insert 4 is obtained in a conventional manner by injection molding using an injection molding mold having a molding cavity with a suitable shape. According to this alternative, the insert 4 is made by simple injection or injection-compression.

The step for providing the complex 6 comprises a step for producing the complex 6 from the layer(s) of ligneous material 10 and the reinforcing layer 8. The complex 6 is manufactured by securing the layer of ligneous material 10 to the reinforcing layer 8 using any known method, for example by gluing the reinforcing layer 8 on the layer of ligneous material 10.

Optionally, the protective layer is further formed on the outer surface of the layer of ligneous material 10.

The assembly of the preformed insert 4 to the complex 6 is for example done by compression according to the teaching of patent application FR 2,929,880.

The assembly step is shown diagrammatically in FIG. 3. In the illustrated embodiment, the preformed insert 4 is assembled to the complex 6 by compression or thermocompression. This compression or thermocompression is done using a compression mold 40 as shown in FIG. 3. The compression mold 40 comprises a first compression mold portion 42 and a second compression mold portion 44 each comprising a receiving surface 46, 48 respectively intended to receive the preformed insert 4 and the complex 6. The receiving surfaces 46, 48 are positioned facing each other. The first portion 42 of the compression mold is movable toward the second portion 44 of the compression mold so as to press the insert 4 and the complex 6 against each other and secure them to obtain the intermediate assembly 16 as output from the mold.

The first portion 42 comprises maintaining means (not shown) for keeping the insert 4 against its receiving surface 46. These maintaining means are for example means for suctioning the insert 4 against the receiving surface 46. In that case, they in particular comprise suction channels extending through the first portion 42. The second portion 44 comprises fastening means (not shown), for example hooks and clips, capable of keeping the complex 6 against its receiving surface 48.

In the case where the assembly is done by thermocompression, the mold 40 comprises heating means (not shown) for heating at least one of the portions 42, 44 of the mold 40 so as to assemble the insert 4 to the complex 6 by thermocompression. These heating means for example allow heating the portion 42, 44 of the mold 40 whose the receiving surface 46, 48 is closer to the contact area between the insert 4 and the complex 6. The heating temperatures are for example above 90° C. and in particular above 130° C. In the illustrated example, the receiving surface 48 of the second portion 44 is closer to the contact area between the insert 4 and the complex 6. The heating means heat the receiving surface 48 of the second portion 44 of the mold 42.

The first portion 42 comprises, on the receiving surface 46 thereof, a resin-based coating 49 attached to the receiving surface 46. The insert 4 is intended to be placed in the mold 40 such that its inner face is applied against the resin-based coating 49. The resin-based coating 49 for example has a thickness substantially comprised between 1 and 10 mm depending on the tolerances calculated in each location of the receiving surface 46. The coating 49 for example has a hardness substantially comprised between 60 shore A and 100 shore A. The coating 49 withstands temperatures above the operating temperatures of the mold 40. This is for example a silicone- or polyurethane-based polymer withstanding temperatures above 90° C., and preferably above 130° C. The coating 49 does not have a shape memory, i.e., it returns to its initial form after each compression. Such a coating 49 makes it possible to apply a uniform pressure on the entire insert 4 during the compression. This thereby avoids poor positioning of the complex 6 with respect to the insert 4.

The step for assembling the insert 4 to the complex 6 illustrated in FIG. 3 is done as follows.

The preformed insert 4 is positioned on the receiving surface 46 of the first portion 42 of the compression mold 40. The inner face of the insert 4 is positioned against the receiving surface 46, in particular against the resin-based coating 49 provided on the receiving surface 46.

The complex 6 is positioned on the receiving surface 48 of the second portion 44 of the mold 40. Its outer face is positioned against the receiving surface 48. The complex 6 is flexible when it is positioned in the mold 40.

Before the mold 40 is closed, the inner face of the reinforcing layer 8 is therefore positioned facing the outer face of the insert 4.

The compression mold 40 is next closed by bringing its first and second portions 42 and 44 close together. The receiving surface 48 is heated using the heating means before and during closing of the mold 40.

Pressure is thus exerted on the insert 4 and the complex 6, and the insert 4 and the complex 6 are secured by thermocompression, the insert 4 adhering to the reinforcing layer 8. Closing the mold 40 also results in shaping of the complex 6.

After cooling, the mold 40 is opened, and the intermediate assembly 16 is stripped.

At the end of the assembly step for assembling the insert 4 to the complex 6, an intermediate assembly 16 is therefore obtained with the desired shape.

Alternatively, the mold 40 is not heated. The insert 4 and the complex 6 are secured by compression. A binder or fastening material may be provided on the outer surface of the insert 4.

The intermediate assembly 16 forms a subassembly of the trim element 1. It comprises the insert 4, secured to the complex 6. More particularly, in the intermediate assembly 16, the outer face of the insert 4 is applied against the inner face of the complex 6, in particular the inner face of the reinforcing layer 8. At the end of the assembly step, the subassembly formed by the insert 4 and the complex 6 has its final shape as found in the trim assembly 1. Within the intermediate assembly 16, the inner face of the complex 6 has a shape substantially complementary to that of the outer face of the insert 4. In the intermediate assembly, the insert 4 adheres to the reinforcing layer 6 of the complex 8.

The step for assembling the complex 6 and the insert 4 to form the intermediate assembly 16 is followed by a step for forming the substrate 2 on the intermediate assembly 16. The substrate 2 is formed on the insert 4, in particular on the inner face of the insert 4 opposite the complex 6. It is formed by injection molding. Thus, the substrate 2 is overmolded by injection on the intermediate assembly 16, more particularly on the inner face of the insert 4.

The step for forming the substrate 2 is shown in FIG. 4. In the illustrated example, the substrate 2 is formed on the intermediate assembly 16 by injecting the first plastic material into a suitable injection molding mold 50. Conventionally, the injection molding mold 50 comprises a first injection molding mold portion 52 and a second injection molding mold portion 54, movable relative to one another. The first injection molding mold portion 52 and the second injection molding mold portion 54 respectively comprise facing surfaces 56, 58 defining a mold cavity between them when the mold 50 is closed. In FIG. 4, the mold 50 is shown in its closed position.

Conventionally, the first portion 52 comprises feed channels 60 for injecting the first plastic material into the molding cavity. The feed channels 60 open out on the surface 56 of the first injection molding mold portion 52. Said surface 56 forms a molding surface.

The surface 58 of the second portion 54 forms a receiving surface, intended to receive the intermediate assembly 16. The intermediate assembly 16 is intended to be positioned in the mold 50 with its outer face applied against the receiving surface 58. The receiving surface 58 of the second portion 54 has a shape substantially complementary to that of the intermediate assembly 16. In the closed position of the mold 50, an injection space is formed between the inner face of the intermediate assembly 16 and the molding surface 56 for injection of the substrate 2. The feed channels 60 open out in said injection space.

The step for forming the substrate 2 takes place as follows. Initially, the mold 50 is open. The intermediate assembly 16 is positioned on the receiving surface 58 of the mold 50. The inner face of the intermediate assembly 16, i.e., the inner face of the insert 4, is oriented toward the molding surface 56. The outer face of the intermediate assembly 16, i.e., the outer face of the complex 6, is oriented toward the receiving surface 58.

According to one embodiment, the substrate 2 is made by simple injection. To that end, the mold 50 is closed after having positioned the intermediate assembly 16 on the receiving surface 58. The first plastic material intended to form the substrate 2 is then injected into the injection space using the feed channels 60 to mold the substrate 2 by injection. The first plastic material fills the injection space and is injected at a temperature comprised between 150° C. and 300° C., the mold being at a temperature comprised between 15° C. and 90° C.

After cooling to a stripping temperature, the mold 50 is opened and the trim element 1 thus obtained is stripped. At the end of this operation, the trim element 1 is obtained as shown in FIG. 1.

Alternatively, the substrate 2 is formed by injection-compression. The method for forming the substrate 2 according to this alternative only differs from the simple injection method in that pressure is exerted on the injected first plastic material at the same time as or after the injection of the latter into the mold 50. Thus, as an example, the first plastic material is injected into the cavity defined by the molding surface 56 and the intermediate assembly when the mold 50 is not yet completely closed, then the mold 50 is closed, thereby reducing the dimensions of the cavity so as to compress the injected plastic material. After cooling to a stripping temperature, the mold 50 is opened and the trim element 1 is stripped.

The overmolding of the substrate 2 on the intermediate assembly 16 may be done according to the teaching of patent application FR 2,949,376.

Inserting a plastic insert between the complex comprising the layer of the ligneous material and the overmolded substrate is advantageous. Indeed, the plastic material is then injected on the insert, and not directly on the textile layer of the complex as in the state of the art. The insert thereby protects the layer of ligneous material during the injection, and prevents deterioration of that layer, and as a result, deterioration of the esthetic appearance of the trim element. One thus obtains a trim element having a wood-like covering with a satisfactory aesthetic appearance.

Furthermore, the method according to the invention can be automated, all of the steps being able to be done by a machine.

Lastly, the trim element is relatively inexpensive. Indeed, the obtained trim element 1 is finished and does not require any subsequent finishing step, such as buffing or varnishing of the trim element. Furthermore, the method makes it possible to integrate functional elements in a single piece with the substrate, even to produce trim elements having a non-developable geometry with a particularly satisfactory compromise between dimensional precision and weight.

1. A vehicle trim element, comprising:
a complex comprising at least one layer of ligneous material having an outer face and an inner face, and a reinforcing layer, extending over the inner face of the layer of ligneous material; and
a substrate made from a first plastic material,
characterized in that the trim element further comprises at least one insert, made from a second plastic material, inserted between the reinforcing layer of the complex and the substrate so as to space the substrate away from the reinforcing layer, the substrate being overmolded by injection on the insert.

2. The trim element according to claim 1, wherein the complex further comprises a protective layer adhering to the outer face of the layer of ligneous material.

3. The trim element according to claim 1, the trim element having a three-dimensional outer surface.

4. The trim element according to claim 1, wherein the insert has a thickness greater than 0.1 mm.

5. The trim element according to claim 1, wherein the second plastic material is chosen from the list consisting of: polyester, polyamide, polyethylene, polypropylene, polycarbonate, acrylonitrile butadiene styrene, acrylic, poly(methyl methacrylate), polybutylene succinate, polybutylene terephthalate, polypropylene terephthalate (PPT), polylactic acid and mixtures of at least two of the aforementioned materials.

6. The trim element according to claim 1, wherein the first and/or second plastic materials contain fibers.

7. The trim element according to claim 1, wherein the substrate comprises at least one functional member made in a single piece with the substrate.

8. A method for manufacturing a trim element, comprising:
providing an insert made from a plastic material;
providing a complex comprising at least one layer of ligneous material having an outer face and an inner face, and a reinforcing layer extending over the inner face of the layer of ligneous material;
assembling the complex to the insert to form an intermediate assembly;
forming the substrate by injection molding the plastic material on the intermediate assembly.

9. The manufacturing method according to claim 8, wherein the insert is shaped separately before being assembled to the complex.

10. The manufacturing method according to claim 8, wherein the trim element has a three-dimensional outer surface and wherein the insert is shaped separately according to its final three-dimensional shape in the trim element before being assembled to the complex.

11. The manufacturing method according to claim 8, wherein the insert is shaped by injection molding, compression or thermocompression.

12. The manufacturing method according to claim 8, wherein the insert is assembled to the complex by pressing the insert against the complex.
